(19) United States
(12) Patent Application Publication
(10) Pub. No.: US 2021/0263321 A1
(43) Pub. Date: Aug. 26, 2021

(54) WEARABLE SMART OPTICAL SYSTEM USING HOLOGRAM OPTICAL ELEMENT

(71) Applicant: PANACEA CORP., Gyeonggi-do (KR)

(72) Inventors: Yun Seok SO, Gyeonggi-do (KR); Heyg Kyu SONG, Gyeonggi-do (KR)

(21) Appl. No.: 17/255,640

(22) PCT Filed: Jun. 17, 2019
(86) PCT No.: PCT/KR2019/007283

§ 371 Date: Dec. 23, 2020

(30) Foreign Application Priority Data
Jun. 29, 2018 (KR) 10-2018-0076062

(51) Int. Cl. G02B 27/01; G09G 3/02; G09G 3/20; G09G 3/3208; G02B 27/48; G02B 26/10; G02B 26/08; G02B 27/28

(52) U.S. Cl. CPC G02B 27/0172; G09G 3/025; G09G 3/2003; G09G 3/3208; G02B 27/48; G02B 2027/012; G02B 26/0833; G02B 27/283; G09G 2320/02; G02B 2027/0174; G02B 26/101

(57) ABSTRACT

The present invention relates to a wearable smart optical system using a hologram optical element (HOE), which is manufactured as a see-through type that can acquire an image while securing an external view, and which displays a converged image to be viewed by the eye in a state in which an HOE image display part is arranged to be parallel with the eye, by enlarging, to a size corresponding to a preset angle of reflection, the image represented by an incident light signal, the HOE image display part being configured as a wavelength-selective transparent reflective body manufactured as a film by recording so as to perform asymmetrical reflection of aligning, with the center of the eye, only a wavelength predefined for the HOE, wherein any one of a laser illumination source, organic light emitting diodes, and an LED RGB illumination source is used as a light source for discharging the incident light signal. According to the present invention, when a user views the outside via the HOE image display part, the outside can be viewed very clearly, as all light introduced from the surrounding is passed through to increase transparency, a very bright and clear image in contrast to the surrounding lighting environment can be achieved, while removing a ghost image caused by unwanted light reflection as in prior art, a near eye display can be miniaturized, made light weight, and manufactured at a low cost, and a phenomenon, in which an image displayed in the HOE image display part is distractingly overlaid in the eye of another person looking at a user wearing the near eye display, can be prevented.

### TECHNICAL FIELD

The present invention relates to an optical system applicable to a near-eye display, and more particularly, to a wearable smart optical system using a hologram optical element (HOE).

### BACKGROUND ART

Near-eye displays are manufactured in the form of a head-mounted display (HMD) or a glass type monitor (GTM) and are generally used for virtual experience devices, video game consoles, virtual training systems, and the like that provide smart environments such as virtual reality (VR), augmented reality (AR), mixed reality (MR), etc.

As types of optical systems applicable to near-eye displays as described above, Patent Document 1 (KR10-2015-0054967 A) discloses an ergonomic head-mounted display device and an optical system, Patent Document 2 (KR10-2018-0085663 A) discloses an optical system and a head-mounted display device, and Patent Document 3 (KR10-1334238 B1) discloses an optical system for a head-mounted display using an optical waveguide.

As disclosed in Patent Documents 1 to 3 above, generally, in an optical system applied to a near-eye display of the related art, an image is displayed using an optical waveguide manufactured in the form of a prism having a predetermined thickness and a three-dimensional structure and thus the optical system has a large volume and a complicated structure.

In particular, because the optical waveguide manufactured in the form of a prism reflects undesired light from surroundings irrespective of a light signal for displaying an image, a user of the near-eye display of the related art using the optical waveguide cannot clearly view the outside, a ghost image may occur due to the reflection of the undesired light, and an image may be relatively dark and blurry when the transparency of the optical waveguide is low as compared to a surrounding lighting environment.

In addition, when the near-eye display of the related art using the optical waveguide manufactured in the form of a prism is used for a virtual experience device, a video game console, a virtual training system, or the like that provides a smart environment such as virtual reality (VR), augmented reality (AR), or mixed reality (MR), images displayed through the optical waveguide may look blurry and overlapped to the eyes of other people who see a user wearing the near-eye display

### DETAILED DESCRIPTION

### Technical Problem

The present invention is directed to providing a wearable smart optical system using a hologram optical element (HOE), which is manufactured as a see-through type to obtain an image while securing an external field of view and in which only a predetermined wavelength is recorded on the HOE to be asymmetrically reflected with respect to the center of the eye so that an image represented by an incident light signal may be enlarged to a size corresponding to a predetermined angle of reflection and converged to be viewable with the eye in a state in which an HOE image display including a film type wavelength-selective transparent reflector is disposed parallel to the eye, and one of a laser illumination, an organic light-emitting diode (OLED), and an LED RGB illumination is used as a light source for emitting the incident light signal.

### Technical Solution

According to an aspect of the present invention, a wearable smart optical system using a hologram optical element (HOE) includes a HOE image display which is a wavelength-selective transparent reflector manufactured in the form of a film stacked on or adhered to an aspherical lens to record only a predetermined wavelength on the HOE to be asymmetrically reflected with respect to a center of an eye, the HOE image display being disposed parallel to the eye to enlarge an image represented by an incident light signal to a size corresponding to a predetermined angle of reflection such that the image is converged and displayed to be viewed with the eye; and a light signal emitter configured to emit a light signal for displaying an image on the HOE image display, wherein the wearable smart optical system is manufactured as a see-through type for obtaining an image while securing an external view.

In the wearable smart optical system using the HOE, the light signal emitter may include a point image emitter configured to emit a point-image color-mixed light signal obtained by mixing point-image color light signals of red (R), green (G), and blue (B), which are emitted from a laser illumination when a point image signal is supplied to the laser illumination, by a combiner to display an image on the HOE image display; and a point image scanner which is a two-dimensional (2D) microelectro-mechanical system (MEMS) scanner in which a scanning mirror is located at a center thereof, the point image scanner being configured to display a plane image, which is obtained by scanning the point-image color-mixed light signal emitted from the point image emitter, on the HOE image display by emitting the point-image color-mixed light signal to the HOE image display by controlling the point-image color-mixed light signal using the scanning mirror according to time on the basis of a horizontal synchronization signal or a vertical synchronization signal synchronized with the point image signal.

In the wearable smart optical system using the HOE, the wearable smart optical system may further include a broad lens unit including at least one or more lenses and configured to remove speckles and adjust an angle at which the point-image color-mixed light signal is incident on the HOE image display when the plane image obtained by scanning the point-image color-mixed light signal emitted from the point image scanner is displayed on the HOE image display.

In the wearable smart optical system using the HOE, the light signal emitter may include an OLED configured to emit a plane image by self-emission to display the plane image on the HOE image display when a plane-image signal is supplied to display an image on the HOE image display.

The wearable smart optical system may further include a broad lens unit including at least one or more lenses and configured to remove speckles and adjust an angle at which the plane image is incident on the HOE image display when a plane-image light signal emitted from the OLED is displayed as the plane image on the HOE image display.

In the wearable smart optical system using the HOE, the light signal emitter may include a color light signal emitter configured to emit, through a light pipe, color light signals of red (R), green (G), and blue (B) sequentially emitted from an LED RGB illumination when a sequential color signal is supplied to the LED RGB illumination to display an image on the HOE image display; a polarizing beam splitter (PBS) configured to reflect only one of a horizontal polarized signal and a vertical polarized signal, which constitute each of the color light signals, and transmit the reflected horizontal or vertical polarized signal to a reflective silicon liquid crystal display (LCoS); and the reflective LCoS configured to produce and reflect a vertical color light signal, which is to be transmitted therethrough, by polarizing, at a right angle, the horizontal polarized signal of each of the color light signals incident via the PBS or to produce and reflect a horizontal color light signal, which is to be transmitted therethrough, by polarizing the vertical polarized signal of each of the color light signals at a right angle, thereby displaying the plane image on the HOE image display.

The wearable smart optical system may further include a broad lens unit including at least one or more lenses and configured to remove speckles and adjust an angle at which the vertical or horizontal color light signal reflected from the reflective LCoS is incident on the HOE image display when the vertical or horizontal color light signal is displayed as a plane image on the HOE image display.

The wearable smart optical system may further include a relay lens configured to adjust an incidence range of a plane-image light signal according to a size of the HOE image display when the plane-image light signal is emitted from an OLED of the light signal emitter to display a plane image on the HOE image display; and a half mirror manufactured using a transparent HOE, disposed between an eye and the HOE image display, and configured to reflect the plane-image light signal, which is transmitted through the relay lens, at an angle of 45 degrees such that the plane-image light signal is projected on the HOE image display at a right angle and reflected to display the plane image matching the size of the HOE image display on the HOE image display.

The wearable smart optical system may further include a relay lens configured to adjust an incidence range of a vertical color light signal or a horizontal color light signal according to a size of the HOE image display when the vertical or horizontal color light signal is reflected by an LCoS of the light signal emitter to display a plane image on the HOE image display; and a half mirror manufactured using a transparent HOE, disposed between an eye and the HOE image display, and configured to reflect the vertical or horizontal color light signal, which is transmitted through the relay lens, at an angle of 45 degrees to be projected on the HOE image display at a right angle and reflected to display the plane image matching the size of the HOE image display on the HOE image display.

### Advantageous Effects

According to the present invention, when a hologram optical element (HOE) image display is configured with a film type wavelength-selective transparent reflector stacked on or adhered on an aspherical lens using a HOE, a user can view the outside very clearly through the HOE image display because light from surroundings is entirely transmitted to increase transparency when the HOE image display is used by being stacked on or adhered on a flat lens for a head-mounted display (HMD) or a curved lens for a glass type monitor (GTM).

In the present invention, an image reflected only with respect to a selected wavelength is displayed through the HOE image display and thus undesired light due to an ambient lighting environment passes through the HOE image display and thus is not reflected, and therefore, a very bright and clear image can be viewed in contrast to the surrounding lighting environment while eliminating ghost images due to reflection of undesired light.

When a HOE image display is manufactured in the form of a film according to the present invention, the HOE image display can be mass-copied at low costs and made smaller and lighter compared to when manufactured in the form of a lens having the same function, and thus, near-eye displays such as an HMD, a GTM, etc. can be made smaller at low costs by using the HOE image display which is a film type.

When a near-eye display such as an HMD or a GTM manufactured using a film type HOE image display according to the present invention is applied to a virtual experience device, a video game console, a virtual training system, etc. that provide a smart environment such as virtual reality (VR), augmented reality (AR), mixed reality (MR), etc., images reflected only with respect to a selected wavelength are displayed through the HOE image display and thus an image displayed on the HOE image display can be prevented from being unfocused and appearing overlapped to the eyes of other people who view a user who wears the near-eye display.

### DESCRIPTION OF DRAWINGS

FIG. 1 illustrates a configuration of a wearable smart optical system using a hologram optical element (HOE) according to a first embodiment of the present invention.

FIG. 2 is a plan view of a configuration of a glass type monitor (GTM) to which the optical system of FIG. 1 is applied.

FIG. 3 illustrates a configuration of a wearable smart optical system using a HOE according to a second embodiment of the present invention.

FIG. 4 illustrates a configuration of a wearable smart optical system using a HOE according to a third embodiment of the present invention.

FIG. 5 illustrates a configuration of a wearable smart optical system using a HOE according to a fourth embodiment of the present invention.

FIG. 6 illustrates a configuration of a wearable smart optical system using a HOE according to a fifth embodiment of the present invention.

### MODES OF THE INVENTION

Hereinafter, embodiments of the present embodiment will be described in more detail with reference to the accompanying drawings.

A wearable smart optical system using a hologram optical element (HOE) according to the present invention to be described below is not limited to the following embodiments, and changes may be made therein by those of ordinary skill in the art without departing from the scope of the present invention as claimed in the following claims.

The wearable smart optical system using the HOE according to the present invention is manufactured as a see-through type that includes a HOE image display and a light signal emitter and is capable of obtaining an image while securing an external field of view.

In the wearable smart optical system using the HOE according to the present invention, an image signal from a terminal (e.g., a mobile computer, a mini computer, or a portable computer) electrically connected to the light signal emitter is emitted in the form of a light signal through the light signal emitter to display an image on the HOE image display.

### First Embodiment

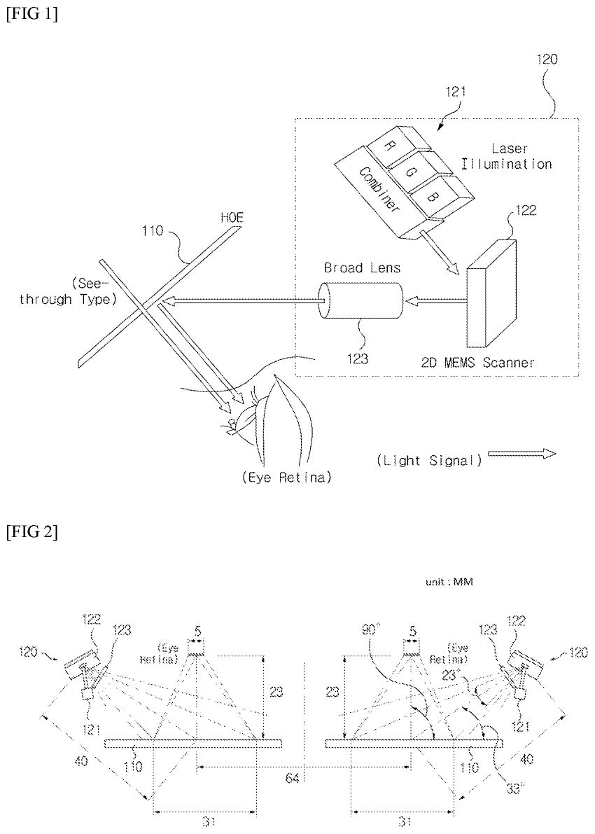

Referring to FIG. 1, a wearable smart optical system using a HOE according to a first embodiment of the present invention includes a HOE image display 110 and a light signal emitter 120.

The HOE image display 110 is a wavelength-selective transparent reflector manufactured in the form of a film stacked on or adhered to an aspherical lens to record only a predetermined wavelength on the HOE to be asymmetrically reflected with respect to the center of the eye and is disposed parallel to the eye to enlarge an image represented by an incident light signal to a size corresponding to a predetermined angle of reflection such that the image may be converged and displayed to be viewed with the eye.

The HOE image display 110 is manufactured in the form of a thin film formed of a photopolymer material and may display a full-color image.

The light signal emitter 120 emits a light signal to display an image on the HOE image display 110.

The light signal emitter 120 includes a point image emitter 121 and a point image scanner 122 and may further include a broad lens unit 123 when necessary.

When point image signal is supplied to a laser illumination to display an image on the HOE image display 110, the point image emitter 121 mixes point-image color light signals of red (R), green (G), and blue (R) emitted from the laser illumination, by a combiner and emits a point-image color-mixed light signal.

The point image scanner 122 is a two-dimensional (2D) microelectro-mechanical system (microelectromechanical system (MEMS)) scanner in which a scanning mirror is located at a center thereof and emits the point-image color-mixed light signal, which is emitted from the point image emitter 121, to the HOE image display 110 by controlling the point-image color-mixed light signal by the scanning mirror according to time on the basis of a horizontal synchronization signal or a vertical synchronization signal, which is synchronized with the point image signal, so that a plane image formed by scanning the point-image color-mixed light signal may be displayed on the HOE image display 110.

The broad lens unit 123 may include at least one or more lenses to remove speckles and adjust an angle at which the point-image color-mixed light signal is incident on the HOE image display 110 when the plane image formed by scanning the point-image color-mixed light signal emitted from the point image scanner 122 is displayed on the HOE image display 110.

The wearable smart optical system using the HOE according to the first embodiment of the present invention operates as follows.

As illustrated in FIG. 1, the wearable smart optical system using the HOE according to the first embodiment of the present invention is manufactured as a see-through type that allows a user to obtain an image while securing an external field of view through the retina of the eye.

In order to display an image on the HOE image display 110, when a point image signal is supplied from a terminal (e.g., a mobile computer, a mini computer, a portable computer or the like) electrically connected to the light signal emitter 120 to the laser illumination of the point image emitter 121, the point image emitter 121 mixes point-image color light signals of red (R), green (G), and blue (B) emitted from the laser illumination by the combiner and emits a point-image color-mixed light signal.

In this case, the point-image color-mixed light signal is produced and emitted in the form of a single dot having a diameter of about 0.7 mm.

Subsequently, when the point-image color-mixed light signal is projected to the scanning mirror at the center of the 2D MEMS scanner of the point image scanner 122, the point image scanner 122 emits the point-image color-mixed light signal to the HOE image display 110 by controlling the point-image color-mixed light signal by the scanning mirror according to time on the basis of a horizontal synchronization signal or a vertical synchronization signal synchronized with the point image signal so that a plane image formed by scanning the point-image color-mixed light signal may be displayed on the HOE image display 110.

In this case, the scanning mirror at the center of the 2D MEMS scanner may have an elliptical shape of 0.7 mm in width and 1 mm in length to be suitable for scanning the point-image color-mixed light signal produced and emitted in the form of a single dot having a diameter of about 0.7 mm.

The point image scanner 122 may scan the point-image color-mixed light signal using the scanning mirror at a frequency determined according to an operating method by resonance, e.g., a frequency of 25 kHz or more for displaying a full HD image, in a horizontal direction and by changing an amplitude in a vertical direction using a sawtooth wave or pulse width modulation method. In this way, an image may be repeatedly scanned thirty times or more per second to display a full HD image, which may be generally viewed on a television, on the HOE image display 110.

The point-image color-mixed light signal scanned by the 2D MEMS scanner of the point image scanner 122 and emitted to the HOE image display 10 is reflected according to an angle of movement of the scanning mirror, thereby maintaining a predetermined angle.

When the point-image color-mixed light signal maintained at the predetermined angle as described above is incident on the HOE image display 110, the HOE image display 110 enlarges an image represented by the incident light signal to a size corresponding to a predetermined angle of reflection such that the image is converged and displayed to be viewed with the eye.

A plane image displayed by the point-image color-mixed light signal projected on the HOE image display 110 is formed by asymmetrically reflecting only a predetermined wavelength with respect to the center of the eye and is enlarged to a size corresponding to the predetermined angle of reflection, such that the image is converged to be viewed with the eye.

Actually, the plane image displayed on the HOE image display 110 is an image reflected from the HOE image display 110 and projected onto the retina of the eye.

In the first embodiment of the present invention implemented as described above, the light signal emitter 120 may be disposed above or at a side of the HOE image display 110 while being inclined at 45 to 60 degrees with respect to an optical axis incident on the HOE image display 110 arranged parallel to the eye. In particular, because the light signal emitter 120 may be disposed at a side of the HOE image display 110, when applied to a glass type monitor (GTM), the light signal emitter 120 may be designed as a rear center-of-gravity type while using a minimum space to reduce the weight of the GTM, and thus a user who wears the GTM can conveniently use the GTM for a long time.

In particular, when the light signal emitter 120 is applied to a GTM while being inclined at 50 degrees or more with respect to an optical axis incident on the HOE image display 110, the broad lens unit 123 may be used so that the point-image color-mixed light signal emitted from the 2D MEMS scanner may be incident parallel to the HOE image display 110.

FIG. 2 is a plan view of a configuration of a GTM to which the optical system of FIG. 1 is applied, in which a pair of left and right optical systems emit light signals from an image signal, which is provided from a terminal (e.g., a mobile computer, a mini-computer, a portable computer or the like) electrically connected to the light signal emitter 120, through the light signal emitter 120 so that an image reflected from the HOE image display 110 may be projected on the retina of the eye.

As a result of measuring a brightness level of an image displayed on the GTM configured as shown in the plan view of FIG. 2 through a numerical analysis, the brightness level of the image viewed through the retina of a user's eyes was 30% or more when an initial brightness level in the laser illumination was 100%.

When a GTM was configured as shown in the plan view of FIG. 2 and the HOE image display 110 was replaced with a display of the related art using an optical waveguide manufactured in the form of a prism, as a result of measuring a brightness level of an image displayed on the GTM through the numerical analysis, the brightness level of the image viewed through the retina of a user's eyes was 3% or less when an initial brightness level of the laser illumination was 100%.

### Second Embodiment

Referring to FIG. 1, a wearable smart optical system using a HOE according to a second embodiment of the present invention includes a HOE image display 110 and a light signal emitter 120a.

The HOE image display 110 is a wavelength-selective transparent reflector manufactured in the form of a film stacked on or adhered to an aspherical lens to record only a predetermined wavelength on the HOE to be asymmetrically reflected with respect to the center of the eye and is disposed parallel to the eye to enlarge an image represented by an incident light signal to a size corresponding to a predetermined angle of reflection such that the image is converged and displayed to be viewed with the eye.

The HOE image display 110 is manufactured in the form of a thin film formed of a photopolymer material and may display a full-color image.

The light signal emitter 120a emits a light signal to display an image on the HOE image display 110.

The light signal emission unit 120a includes an organic light-emitting diode (OLED) 121a and may further include a broad lens unit 122a if necessary.

When a plane image signal is supplied to display an image on the HOE image display 110, the OLED 121a emits the plane image light signal by self-emission so as to display the plane image on the HOE image display 110.

The broad lens unit 122a may include one or more lenses to remove speckles when the plane image light signal emitted from the OLED 121a is displayed as a plane image on the HOE image display 110 and to adjust an angle at which the plane image is incident on the HOE image display 110.

The wearable smart optical system using the HOE according to the second embodiment of the present invention operates as follows.

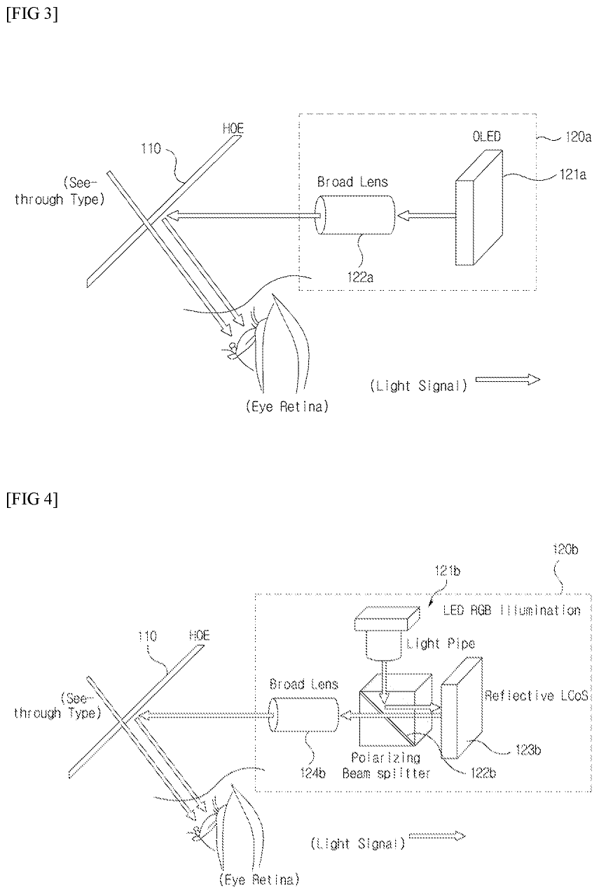

As illustrated in FIG. 3, the wearable smart optical system using the HOE according to the second embodiment of the present invention is manufactured as a see-through type that allows a user to obtain an image while securing an external field of view through the retina of the eye.

In order to display an image on the HOE image display 110, the OLED 121a emits a plane-image light signal by self-emission when a plane image signal is supplied from a terminal (e.g., a mobile computer, a mini computer, a portable computer, or the like) electrically connected to the light signal emitter 120.

In this case, the plane image light signal is produced and emitted in a plane form and is maintained at a predetermined angle.

When the plane image light signal maintained at the predetermined angle is emitted from the OLED 121a and is incident on the HOE image display 110, the HOE image display 110 enlarges an image represented by the incident light signal to a size corresponding to a predetermined angle of reflection such that the image is converted and displayed to be viewed with the eyes.

The plane image displayed on the HOE image display 110 is an image formed by asymmetrically reflecting only a predetermined wavelength with respect to the center of the eye and enlarged to a size corresponding to a predetermined angle of reflection such that the image may be converged to be viewed with the eye.

Actually, the plane image displayed on the HOE image display 110 is an image reflected from the HOE image display 110 and projected onto the retina of the eye.

In the second embodiment of the present invention implemented as described above, the light signal emitter 120a may be disposed above or at a side of the HOE image display 110 while being inclined at 45 to 60 degrees with respect to an optical axis incident on the HOE image display 110 arranged parallel to the eye. In particular, because the light signal emitter 120a may be disposed at a side of the HOE image display 110, when applied to a GTM, the light signal emitter 120a may be designed as a rear center-of-gravity type while using a minimum space to reduce the weight of the GTM, and thus a user who wears the GTM can conveniently use the GTM for a long time.

In particular, when the light signal emitter 120a is applied to a GTM while being inclined at 50 degrees or more with respect to an optical axis incident on the HOE image display 110, the broad lens unit 122a may be used so that the plane image light signal emitted from the OLED 121a may be incident parallel to the HOE image display 110.

An embodiment in which the optical system according to the second embodiment of the present invention is applied to the GTM of FIG. 2 may be implemented.

That is, an embodiment in which the light signal emitter 120 using the laser illumination according to the first embodiment of the present invention of FIG. 2 is replaced with the light signal emitter 120a using the OLED 121a according to the second embodiment of the present invention may be implemented.

In this case, a pair of left and right optical systems according to the second embodiment each emit an image signal, which is provided from a terminal (e.g., a mobile computer, a mini computer, a portable computer or the like) electrically connected to the light signal emitter 120a, in the form of a plane image light signal through the light signal emitter 120a so that an image reflected from the HOE image display 110 may be projected to the retina of the eye.

In addition, similar to the first embodiment described above with reference to FIG. 2, as a result of measuring a brightness level of an image displayed on the GTM, to which the pair of left and right optical systems of the second embodiment are applied, through a numerical analysis, the brightness level of the image viewed through the retina of a user's eye was 10% or more when an initial brightness level on the OLED 121a was 100%.

Compared to the case in which the brightness level of the image viewed through the retina of the eye was 30% or more when the laser illumination according to the first embodiment of the present invention of FIG. 2 was used, the brightness level of the image was reduced by about 20%, i.e., to 10% or more, because optical loss occurred in a bandwidth of a wavelength of a light signal emitted from the OLED 121a due to a function of reflecting a certain wavelength of a film type wavelength-selective transparent reflector, which is the HOE, of the HOE image display 110.

When a GTM was configured as shown in the plan view of FIG. 2 and the HOE image display 110 was replaced with a display of the related art using an optical waveguide manufactured in the form of a prism, as a result of measuring a brightness level of an image displayed on the GTM through the numerical analysis, the brightness level of the image viewed through the retina of a user's eyes was 3% or less when an initial brightness level in the OLED 121a was 100%.

### Third Embodiment

Referring to FIG. 4, a wearable smart optical system using a HOE according to a third embodiment of the present invention includes a HOE image display 110 and a light signal emitter 120b.

The HOE image display 110 is a wavelength-selective transparent reflector manufactured in the form of a film stacked on or adhered to an aspherical lens to record only a predetermined wavelength on the HOE to be asymmetrically reflected with respect to the center of the eye and is disposed parallel to the eye to enlarge an image represented by an incident light signal to a size corresponding to a predetermined angle of reflection such that the image is converged and displayed to be viewed with the eye.

The HOE image display 110 is manufactured in the form of a thin film formed of a photopolymer material and may be capable of displaying a full-color image.

The light signal emitter 120b emits a light signal to display an image on the HOE image display 110.

The light signal emitter 120b includes a color light signal emitter 121b, a polarization beam splitter (PBS) 122b, and a reflective silicon liquid crystal display (LCoS) 123b and may further include a broad lens unit 124b when necessary.

When a sequential color signal is supplied to an LED RGB illumination to display an image on the HOE image display 110, the color light signal emitter 121b emits color light signals of red (R), green (G), and blue (B), which are sequentially emitted from the LED RGB illumination, through a light pipe.

The PBS 122b reflects only one of a horizontally polarized signal and a vertically polarized signal, which constitute each of the color light signals, and transmits the reflected signal to the LCoS 123b.

The LCoS 123b polarizes the horizontally polarized signal of the color light signal, which is incident via the PBS 122b, by 90 degrees to obtain and reflect a vertical color light signal to be transmitted through the PBS 122b, or polarizes the vertically polarized signal of the color light signal, which is incident via the PBS 122b, by 90 degrees to obtain and reflect a horizontal color light signal to be transmitted through the PBS 122b, thereby displaying a plane image on the HOE image display 110.

When the vertical or horizontal color light signal reflected by the LCoS 123b is displayed as a plane image on the HOE image display 110, the broad lens unit 124b may include at least one or more lenses or a plurality of lenses to remove speckles and adjust an angle at which the vertical or horizontal color light signal is incident on the HOE image display 110.

The wearable smart optical system using the HOE according to the third embodiment of the present invention operates as follows.

As illustrated in FIG. 4, the wearable smart optical system using the HOE according to the third embodiment of the present invention is a manufactured as a see-through type that allows a user to obtain an image while securing an external field of view through the retina of the eye.

In order to display an image on the HOE image display 110, when a sequential color signal is supplied to the LED RGB illumination of the color light signal emitter 121b from a terminal (e.g., a mobile computer, a mini computer, a portable computer or the like) electrically connected to the light signal emitter 120b, the color light signal emitter 121b emits color light signals of red (R), green (G), and blue (B), which are sequentially emitted from the LED RGB illumination, through the light pipe.

In this case, the color light signals are each produced and emitted in a plane form.

Subsequently, when the color light signal is projected to the PBS 122b, the PBS 122b reflects one of a horizontally polarized signal and a vertically polarized signal, which constitute the color light signal, and transmit the reflected signal to the LCoS 123b.

The LCoS 123b polarizes the horizontally polarized signal of the color light signal, which is incident via the PBS 122b, by 90 degrees to obtain and reflect a vertical color light signal to be transmitted through the PBS 122b, or polarizes the vertically polarized signal of the color light signal, which is incident via the PBS 122b, by 90 degrees to obtain and reflect a horizontal color light signal to be transmitted through the PBS 122b, thereby displaying a plane image on the HOE image display 110.

In this case, the vertical or horizontal color light signal reflected from the LCoS 123b is reflected while being maintained at a predetermined angle to be displayed as a plane image.

When the vertical or horizontal color light signal maintained at the predetermined angle as described above is incident on the HOE image display 110, the HOE image display 110 enlarges an image represented by the incident light signal to a size corresponding to a predetermined angle of reflection such that the image is converged and displayed to be viewed with the eye.

The plane image displayed on the HOE image display 110 is an image formed by asymmetrically reflecting only a predetermined wavelength with respect to the center of the eye and enlarged to a size corresponding to a predetermined angle of reflection such that the image may be converged to be viewed with the eye.

Actually, the plane image displayed on the HOE image display 110 is an image reflected from the HOE image display 110 and projected onto the retina of the eye.

In the third embodiment of the present invention implemented as described above, the light signal emitter 120b may be disposed above or at a side of the HOE image display 110 while being inclined at 45 to 60 degrees with respect to an optical axis incident on the HOE image display 110 arranged parallel to the eye. In particular, because the light signal emitter 120b may be disposed at a side of the HOE image display 110, when applied to a GTM, the light signal emitter 120b may be designed as a rear center-of-gravity type while using a minimum space to reduce the weight of the GTM, and thus a user who wears the GTM can conveniently use the GTM for a long time.

In particular, when the light signal emitter 120b is applied to a GTM while being inclined at 50 degrees or more with respect to an optical axis incident on the HOE image display 110, the broad lens unit 123 may be used so that the plane image light signal emitted from the OLED 121a may be incident parallel with the HOE image display 110.

An embodiment in which the optical system according to the third embodiment of the present invention is applied to the GTM of FIG. 2 may be implemented.

That is, an embodiment in which the light signal emitter 120 using the laser illumination according to the first embodiment of the present invention of FIG. 2 is replaced with the light signal emitter 120b using the LED RGB illumination according to the third embodiment of the present invention may be implemented.

In this case, a pair of left and right optical systems according to the third embodiment each emit an image signal, which is provided from a terminal (e.g., a mobile computer, a mini computer, a portable computer or the like) electrically connected to the light signal emitter 120b, in the form of a plane image light signal through the light signal emitter 120b so that an image reflected from the HOE image display 110 may be projected to the retina of the eye.

In addition, similar to the first embodiment described above with reference to FIG. 2, as a result of measuring a brightness level of an image displayed on the GTM, to which the pair of left and right optical systems of the third embodiment are applied, through a numerical analysis, the brightness level of the image viewed through the retina of a user's eye was 10% or more when an initial brightness level of the LED RGB illumination was 100%.

Compared to the case in which the brightness level of the image viewed through the retina of the eye was 30% or more when the laser illumination according to the first embodiment of the present invention of FIG. 2 was used, the brightness level of the image was reduced by about 20%, i.e., to 10% or more, because optical loss occurred in a bandwidth of a wavelength of a light signal emitted from the LED RGB illumination due to a function of reflecting a certain wavelength of a film type wavelength-selective transparent reflector, which is an HOE, of the HOE image display 110.

When a GTM was configured as shown in the plan view of FIG. 2 and the HOE image display 110 was replaced with a display of the related art using an optical waveguide manufactured in the form of a prism, as a result of measuring a brightness level of an image displayed on the GTM through the numerical analysis, the brightness level of the image viewed through the retina of a user's eyes was 3% or less when an initial brightness level of the LED RGB illumination was 100%.

### Fourth Embodiment

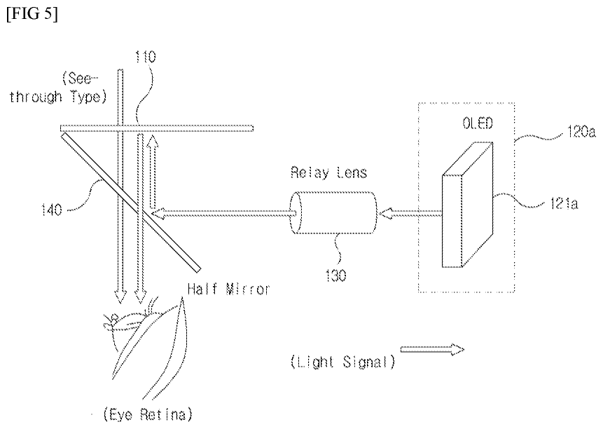

Referring to FIG. 5, a wearable smart optical system using a HOE according to a fourth embodiment of the present invention includes a HOE image display 110, a light signal emitter 120a, a relay lens 130, and a half mirror 140.

The HOE image display 110 is a wavelength-selective transparent reflector manufactured in the form of a film stacked on or adhered to an aspherical lens to record only a predetermined wavelength on the HOE to be asymmetrically reflected with respect to the center of the eye and is disposed parallel to the eye to enlarge an image represented by an incident light signal to a size corresponding to a predetermined angle of reflection such that the image is converged and displayed to be viewed with the eye.

The HOE image display 110 is manufactured in the form of a thin film formed of a photopolymer material and may display a full-color image.

The light signal emitter 120a emits a light signal to display an image on the HOE image display 110.

The light signal emitting part 120a includes an OLED 121a.

When a plane image signal is supplied to display an image on the HOE image display 110, the OLED 121a emits the plane-image light signal by self-emission so as to display the plane image on the HOE image display 110.

When the OLED 121a of the light signal emitter 120a emits a plane image light signal to display a plane image on the HOE image display 110, the relay lens 130 adjusts an incidence range of the plane image light signal according to a size of the HOE image display 110.

The half mirror 140 is manufactured using a transparent HOE, is provided between the eye and the HOE image display 110, and reflects a plane image light signal, which passes through the relay lens 130, at an angle of 45 degrees, so that the plane image light signal may be projected at a right angle to the HOE image display 110 and thereafter reflected, thereby displaying on the HOE image display 110 a plane image adjusted to the size of the HOE image display 110.

The wearable smart optical system using the HOE according to the fourth embodiment of the present invention operates as follows.

As illustrated in FIG. 5, the wearable smart optical system using the HOE according to the fourth embodiment of the present invention is manufactured as a see-through type that allows a user to obtain an image while securing an external field of view through the retina of the eye.

In order to display an image on the HOE image display 110, the OLED 121a emits a plane-image light signal by self-emission when a plane image signal is supplied from a terminal (e.g., a mobile computer, a mini computer, a portable computer, or the like) electrically connected to the light signal emitter 120.

In this case, the plane image light signal is produced and emitted in a plane form and maintained at a predetermined angle.

When a plane image light signal maintained at a predetermined angle as described above is emitted from the OLED 121a and is incident on the relay lens 130, the relay lens 130 adjusts an incidence range of the plane image light signal according to the size of the HOE image display 110.

Subsequently, when the plane image signal transmitted through the relay lens 130 is incident on the half mirror 140, the half mirror 140 reflects the plane image light signal at an angle of 45 degrees to be projected at a right angle to and reflected from the HOE image display 110.

Accordingly, the HOE image display 110 reflects only the plane image light signal incident at the right angle to display a plane image matching the size of the HOE image display 110.

The plane image displayed on the HOE image display 110 is an image formed by asymmetrically reflecting only a predetermined wavelength with respect to the center of the eye and enlarged to a size corresponding to a predetermined angle of reflection such that the image may be converged to be viewed with the eye.

Actually, the plane image displayed on the HOE image display 110 is an image reflected from the HOE image display 110 and projected onto the retina of the eye.

In the fourth embodiment of the present invention implemented as described above, the light signal emitter 120a may be provided above or at a side of the half mirror 140 through which a light signal is incident at a right angle on the HOE image display 110 parallel to the eye. In particular, because the light signal emitter 120a may be provided at a side of the half mirror 140, when applied to a GTM, the light signal emitter 120a may be designed as a rear center-of-gravity type while using a minimum space to reduce the weight of the GTM, and thus a user who wears the GTM can conveniently use the GTM for a long time.

An embodiment in which the optical system according to the fourth embodiment of the present invention is applied to the GTM of FIG. 2 may be implemented.

That is, an embodiment in which the light signal emitter 120 using the laser illumination according to the first embodiment of the present invention of FIG. 2 is replaced with the light signal emitter 120a using the OLED 121a according to the fourth embodiment of the present invention may be implemented.

In this case, a pair of left and right optical systems according to the fourth embodiment each emit an image signal, which is provided from a terminal (e.g., a mobile computer, a mini computer, a portable computer or the like) electrically connected to the light signal emitter 120a, in the form of a plane image light signal through the light signal emitter 120a so that an image reflected from the HOE image display 110 may be projected to the retina of the eye.

In addition, similar to the first embodiment described above with reference to FIG. 2, as a result of measuring a brightness level of an image displayed on the GTM, to which the pair of left and right optical systems of the fourth embodiment are applied, through a numerical analysis, the brightness level of the image viewed through the retina of a user's eye was 10% or more when an initial brightness level on the OLED 121a was 100%.

Compared to the case in which the brightness level of the image viewed through the retina of the eye was 30% or more when the laser illumination according to the first embodiment of the present invention of FIG. 2 was used, the brightness level of the image was reduced by about 20%, i.e., to 10% or more, because optical loss occurred in a bandwidth of a wavelength of a light signal emitted from the OLED 121a due to a function of reflecting a certain wavelength of a film type wavelength-selective transparent reflector, which is an HOE, of the HOE image display 110.

When a GTM was configured as shown in the plan view of FIG. 2 and the HOE image display 110 was replaced with a display of the related art using an optical waveguide manufactured in the form of a prism, as a result of measuring a brightness level of an image displayed on the GTM through the numerical analysis, the brightness level of the image viewed through the retina of a user's eyes was 3% or less when an initial brightness level in the OLED 121a was 100%.

### Fifth Embodiment

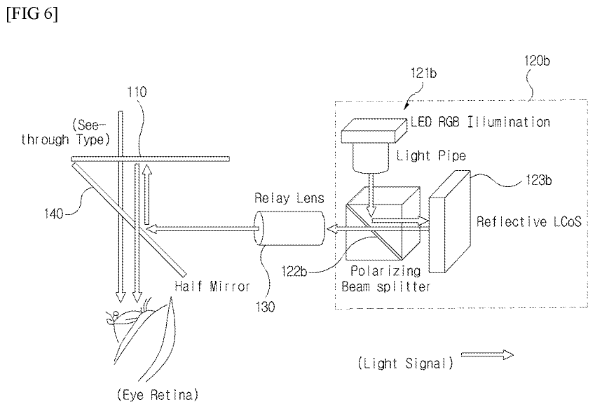

Referring to FIG. 6, a wearable smart optical system using a HOE according to a fifth embodiment of the present invention includes a HOE image display 110, a light signal emitter 120b, a relay lens 130, and a half mirror 140.

The HOE image display 110 is a wavelength-selective transparent reflector manufactured in the form of a film stacked on or adhered to an aspherical lens to record only a predetermined wavelength on the HOE to be asymmetrically reflected with respect to the center of the eye, and is disposed parallel to the eye to enlarge an image represented by an incident light signal to a size corresponding to a predetermined angle of reflection so that the image may be converged and displayed to be viewed with the eye.

The HOE image display 110 is manufactured in the form of a thin film formed of a photopolymer material and may be capable of displaying a full-color image.

The light signal emitter 120b emits a light signal to display an image on the HOE image display 110.

The light signal emitter 120b includes a color light signal emitter 121b, a PBS 122b, and an LCoS 123b.

When a sequential color signal is supplied to an LED RGB illumination to display an image on the HOE image display 110, the color light signal emitter 121b emits color light signals of red (R), green (G), and blue (B), which are sequentially emitted from the LED RGB illumination, through a light pipe.

The PBS 122b reflects only one of a horizontally polarized signal and a vertically polarized signal, which constitute each of the color light signals, and transmits the reflected signal to the LCoS 123b.

The LCoS 123b polarizes the horizontally polarized signal of the color light signal, which is incident via the PBS 122b, by 90 degrees to obtain and reflect a vertical color light signal to be transmitted through the PBS 122b, or polarizes the vertically polarized signal of the color light signal, which is incident via the PBS 122b, by 90 degrees to obtain and reflect a horizontal color light signal to be transmitted through the PBS 122b, thereby displaying a plane image on the HOE image display 110.

When the LCoS 123b of the light signal emitter 120b reflects a vertical or horizontal color light signal to display a plane image on the HOE image display 110, the relay lens 130 adjusts an incidence range of the vertical or horizontal color light signal according to a size of the HOE image display 110.

The half mirror 140 is manufactured using a transparent HOE, is provided between the eye and the HOE image display 110, and reflects the vertical or horizontal color light signal, which passes through the relay lens 130, at an angle of 45 degrees, so that the vertical or horizontal color light signal may be projected at a right angle to the HOE image display 110 and thereafter reflected, thereby displaying on the HOE image display 110 a plane image adjusted to the size of the HOE image display 110.

The wearable smart optical system using the HOE according to the fifth embodiment of the present invention operates as follows.

As illustrated in FIG. 6, the wearable smart optical system using the HOE according to the fifth embodiment of the present invention is manufactured as a see-through type that allows a user to obtain an image while securing an external field of view through the retina of the eye.

In order to display an image on the HOE image display 110, when a sequential color signal is supplied to the LED RGB illumination of the color light signal emitter 121b from a terminal (e.g., a mobile computer, a mini computer, a portable computer or the like) electrically connected to the light signal emitter 120b, the color light signal emitter 121b emits color light signals of red (R), green (G), and blue (B), which are sequentially emitted from the LED RGB illumination, through the light pipe.

In this case, the color light signals are each produced and emitted in a plane form.

Subsequently, when the color light signal is projected to the PBS 122b, the PBS 122b reflects one of a horizontally polarized signal and a vertically polarized signal, which constitute the color light signal, and transmit the reflected signal to the LCoS 123b.

The LCoS 123b polarizes the horizontally polarized signal of the color light signal, which is incident via the PBS 122b, by 90 degrees to obtain and reflect a vertical color light signal to be transmitted through the PBS 122b, or polarizes the vertically polarized signal of the color light signal, which is incident via the PBS 122b, by 90 degrees to obtain and reflect a horizontal color light signal to be transmitted through the PBS 122b, thereby displaying a plane image on the HOE image display 110.

In this case, the vertical or horizontal color light signal reflected from the LCoS 123b is reflected while being maintained at a predetermined angle to be displayed as a plane image.

When a plane image light signal maintained at a predetermined angle as described above is emitted from the LCoS 123b and is incident on the relay lens 130, the relay lens 130 adjusts an incidence range of the plane image light signal according to the size of the HOE image display 110.

Subsequently, when the plane image signal transmitted through the relay lens 130 is incident on the half mirror 140, the half mirror 140 reflects the plane image light signal at an angle of 45 degrees to be projected at a right angle to and reflected from the HOE image display 110.

Accordingly, the HOE image display 110 reflects only the plane image light signal incident at the right angle to display a plane image matching the size of the HOE image display 110.

The plane image displayed on the HOE image display 110 is an image formed by asymmetrically reflecting only a predetermined wavelength with respect to the center of the eye and enlarged to a size corresponding to a predetermined angle of reflection such that the image may be converged to be viewed with the eye.

Actually, the plane image displayed on the HOE image display 110 is an image reflected from the HOE image display 110 and projected onto the retina of the eye.

In the fifth embodiment of the present invention implemented as described above, the light signal emitter 120b may be provided above or at a side of the half mirror 140 through which a light signal is incident at a right angle on the HOE image display 110 parallel to the eye. In particular, because the light signal emitter 120b may be provided at a side of the half mirror 140, when applied to a GTM, the light signal emitter 120b may be designed as a rear center-of-gravity type while using a minimum space to reduce the weight of the GTM, and thus a user who wears the GTM can conveniently use the GTM for a long time.

An embodiment in which the optical system according to the fifth embodiment of the present invention is applied to the GTM of FIG. 2 may be implemented.

That is, an embodiment in which the light signal emitter 120 using the laser illumination according to the first embodiment of the present invention of FIG. 2 is replaced with the light signal emitter 120b using the LED RGB illumination according to the fifth embodiment of the present invention may be implemented.

In this case, a pair of left and right optical systems according to the fifth embodiment each emit an image signal, which is provided from a terminal (e.g., a mobile computer, a mini computer, a portable computer or the like) electrically connected to the light signal emitter 120b, in the form of a plane image light signal through the light signal emitter 120b so that an image reflected from the HOE image display 110 may be projected to the retina of the eye.

In addition, similar to the first embodiment described above with reference to FIG. 2, as a result of measuring a brightness level of an image displayed on the GTM, to which the pair of left and right optical systems of the fifth embodiment are applied, through a numerical analysis, the brightness level of the image viewed through the retina of a user's eye was 10% or more when an initial brightness level of the LED RGB illumination was 100%.

Compared to the case in which the brightness level of the image viewed through the retina of the eye was 30% or more when the laser illumination according to the first embodiment of the present invention of FIG. 2 was used, the brightness level of the image was reduced by about 20%, i.e., to 10% or more, because optical loss occurred in a bandwidth of a wavelength of a light signal emitted from the LED RGB illumination due to a function of reflecting a certain wavelength of a film type wavelength-selective transparent reflector, which is an HOE, of the HOE image display 110.

When a GTM was configured as shown in the plan view of FIG. 2 and the HOE image display 110 was replaced with a display of the related art using an optical waveguide manufactured in the form of a prism, as a result of measuring a brightness level of an image displayed on the GTM through the numerical analysis, the brightness level of the image viewed through the retina of a user's eyes was 3% or less when an initial brightness level of the LED RGB illumination was 100%.

As described above, when the HOE image display 110 configured with a film type wavelength-selective transparent reflector according to the optical system according to one of the first to fifth embodiments of the present invention is used by being stacked on or adhered on a flat lens for a head-mounted display (HMD) or a curved lens for a GTM, a user can clearly see the outside through the HOE image display 110 because light from the surroundings is entirely transmitted to increase transparency.

In particular, according to the present invention, an image reflected only with respect to a selected wavelength is displayed through the HOE image display 110, undesired light due to an ambient lighting environment passes through the HOE image display 110 and thus is not reflected, and therefore, a very bright and clear image can be viewed in contrast to the surrounding lighting environment while eliminating ghost images caused by reflection of undesired light.

When the HOE image display 110 is manufactured in the form of a film according to the present invention, the HOE image display 110 can be mass-copied at a low cost and made smaller and lighter compared to when manufactured in the form of a lens having the same function, and thus, near-eye displays such as an HMD, a GTM, etc. can be made smaller at a low cost by using the HOE image display 110 which is a film type.

In addition, when a near-eye display such as an HMD or a GTM manufactured using the HOE image display 110 in the form of a film according to the present invention is applied to a virtual experience device, a video game console, a virtual training system, etc. that provide a smart environment such as VR, AR, MR, etc., images reflected only with respect to a selected wavelength are displayed through the HOE image display 110 and thus an image displayed on the HOE image display 110 can be prevented from being unfocused and appearing overlapped to the eyes of other people who view a user who wears the near-eye display.

1. A wearable smart optical system using a hologram optical element (HOE), comprising:
a HOE image display which is a wavelength-selective transparent reflector manufactured in the form of a film stacked on or adhered to an aspherical lens to record only a predetermined wavelength on the HOE to be asymmetrically reflected with respect to a center of an eye, the HOE image display being disposed parallel to the eye to enlarge an image represented by an incident light signal to a size corresponding to a predetermined angle of reflection such that the image is converged and displayed to be viewed with the eye; and
a light signal emitter configured to emit a light signal for displaying an image on the HOE image display,
wherein the wearable smart optical system is manufactured as a see-through type for obtaining an image while securing an external view.

2. The wearable smart optical system of claim 1, wherein the light signal emitter comprises:
a point image emitter configured to emit a point-image color-mixed light signal obtained by mixing point-image color light signals of red (R), green (G), and blue (B), which are emitted from a laser illumination when a point image signal is supplied to the laser illumination, by a combiner to display an image on the HOE image display; and
a point image scanner which is a two-dimensional (2D) microelectro-mechanical system (MEMS) scanner in which a scanning mirror is located at a center thereof, the point image scanner being configured to display a plane image, which is obtained by scanning the point-image color-mixed light signal emitted from the point image emitter, on the HOE image display by emitting the point-image color-mixed light signal to the HOE image display by controlling the point-image color-mixed light signal using the scanning mirror according to time on the basis of a horizontal synchronization signal or a vertical synchronization signal synchronized with the point image signal.

3. The wearable smart optical system of claim 2, further comprising a broad lens unit including at least one or more lenses and configured to remove speckles and adjust an angle at which the point-image color-mixed light signal is incident on the HOE image display when the plane image obtained by scanning the point-image color-mixed light signal emitted from the point image scanner is displayed on the HOE image display.

4. The wearable smart optical system of claim 1, wherein the light signal emitter comprises organic light-emitting diodes (OLEDs) configured to emit a plane image by self-emission to display the plane image on the HOE image display when a plane-image signal is supplied to display an image on the HOE image display.

5. The wearable smart optical system of claim 4, further comprising a broad lens unit including at least one or more lenses and configured to remove speckles and adjust an angle at which the plane image is incident on the HOE image display when a plane-image light signal emitted from the OLED is displayed as the plane image on the HOE image display.

6. The wearable smart optical system of claim 1, wherein the light signal emitter comprises:
a color light signal emitter configured to emit, through a light pipe, color light signals of red (R), green (G), and blue (B) sequentially emitted from a light-emitting diode (LED) RGB illumination when a sequential color signal is supplied to the LED RGB illumination to display an image on the HOE image display;
a polarizing beam splitter (PBS) configured to reflect only one of a horizontal polarized signal and a vertical polarized signal, which constitute each of the color light signals, and transmit the reflected horizontal or vertical polarized signal to a reflective silicon liquid crystal display (LCoS); and
the reflective LCoS configured to produce and reflect a vertical color light signal, which is to be transmitted therethrough, by polarizing, at a right angle, the horizontal polarized signal of each of the color light signals incident via the PBS or to produce and reflect a horizontal color light signal, which is to be transmitted therethrough, by polarizing the vertical polarized signal of each of the color light signals at a right angle, thereby displaying the plane image on the HOE image display.

7. The wearable smart optical system of claim 6, further comprising a broad lens unit including at least one or more lenses and configured to remove speckles and adjust an angle at which the vertical or horizontal color light signal reflected from the reflective LCoS is incident on the HOE image display when the vertical or horizontal color light signal is displayed as a plane image on the HOE image display.

8. The wearable smart optical system of claim 1, further comprising:
a relay lens configured to adjust an incidence range of a plane-image light signal according to a size of the HOE image display when the plane-image light signal is emitted from an organic light-emitting diode (OLED) of the light signal emitter to display a plane image on the HOE image display; and
a half mirror manufactured using a transparent HOE, disposed between an eye and the HOE image display and configured to reflect the plane-image light signal, which is transmitted through the relay lens, at an angle of 45 degrees such that the plane-image light signal is projected on the HOE image display at a right angle and reflected to display the plane image matching the size of the HOE image display on the HOE image display.

9. The wearable smart optical system of claim 1, further comprising:
a relay lens configured to adjust an incidence range of a vertical color light signal or a horizontal color light signal according to a size of the HOE image display when the vertical or horizontal color light signal is reflected by a reflective silicon liquid crystal display (LCoS) of the light signal emitter to display a plane image on the HOE image display; and
a half mirror manufactured using a transparent HOE, disposed between an eye and the HOE image display and configured to reflect the vertical or horizontal color light signal, which is transmitted through the relay lens, at an angle of 45 degrees to be projected on the HOE image display at a right angle and reflected to display the plane image matching the size of the HOE image display on the HOE image display.
